(19) United States
(12) Patent Application Publication
(10) Pub. No.: US 2004/0037604 A1
(43) Pub. Date: Feb. 26, 2004

(54) Ergonomic hand-held computing deivce

(76) Inventors: Brian J. McNamara, Amherst, MA (US); Gareth Johnson, Royston (GB)

Correspondence Address: Mr. Brian J. McNamara, 3 Red Fox Lane, Amherst, MA, 01002, US

(21) Appl. No.: 10/353,521

(22) Filed: Jan. 28, 2003

Related U.S. Application Data
(60) Provisional application No. 60/404,938, filed on Aug. 22, 2002.

(51) Int. Cl. B41J 5/00

(52) U.S. Cl. 400/88

(57) ABSTRACT

A hand-held computing device including a pair of grouped buttons disposed in a pattern including at least one row, such that each input device in each row is substantially equidistant from a location or point unique to each group is used to optimize the use of the user's thumbs for data input. The use of the thumb is the most powerful digit on the hand and has the greatest range of motion. Using only the thumbs to actuate the buttons of computing device such as a calculator, allows the hand to remain less obtrusive to the accessing the buttons, therefore less prone to input errors. In addition, by maintaining the relative position of the rest of the hand at a consistent location on the housing, the user's proprioceptive and kinesthetic senses allow the user to learn and consistently locate keys. Upon this learning, the user would be able to input data without visual cues further increasing efficiency with a short learning curve.

This application claims the benefit of Provisional Application No. 60/404,938, filed Aug. 22, 2002.

### FIELD OF THE INVENTION

The present invention generally relates to hand-held electronic devices. More specifically, the present invention relates to hand-held computing devices such as calculators.

### BACKGROUND OF THE INVENTION

Electronic calculators have become a part of our modern culture. Slide rules of yesteryear are looked upon as part of the pre-history of modern science and mathematics, even though handheld electronic calculators were not available until Large Scale Integration made it possible to squeeze thousands of transistors into a small block of silicon. This process has only been available since the mid 1960's. Low cost calculators and video games made popular in the 1970's and 1980's reached ever-increasing popularity in the 1990's and even today. Due to the reduced size of the device relative to a computer keyboard or typewriter, placing the hand over the input keys is very obstructive and cumbersome. As a result it is advantageous for the user's thumbs to function as the primary functional input digit of the user's hands. The remaining fingers (phalanges) are primarily used as holders to hang onto the body of the device and oppose the forces applied by the thumbs as they contact the buttons or keys of the device. The smaller size keypad of electronic devices presents a new need not seen in the former days of forefinger “hunt and peck” typers and keyboard users. These devices were not designed to be thumb actuated devices. This new user format has given rise to a new type of calculator and other multiple key hand-held electronic input devices.

### SUMMARY OF THE INVENTION

In one aspect, the invention features a hand-held calculator with a housing that includes two adjacent side portions and a display device that is located between the side portions. A pair of grouped input devices is disposed between the side portions and arranged in a pattern that includes at least one row, such that each input device in each row is substantially equidistant from a location or point unique to each group.

The system may also include input devices that consist of pressure sensitive buttons arranged in a pattern such as an arc. The pattern may include at least two substantially parallel arcs. The pattern may also comprise at least one row that is arranged in a polar coordinate system or a row arranged in a rectangular coordinate system. The location unique to each group may be near the centroid of each group or near each of the two adjacent side portions, specifically near a bottom edge of the two adjacent side portions.

The device may further include a set of finger grips at each of the two adjacent side portions. The input devices may be varied in height relative to a backside of the calculator. This varied height may include two rows of input devices, each row providing a unique height relative to the backside. This variation in height preferably includes the row nearer the location or point unique to each group as being lower than a row further away from the location or point unique to each group.

In another aspect, the invention includes a method of using a calculator including providing a calculator as previously disclosed, grasping the calculator by a user with a right thumb being accessible to a first of the grouped input devices and a left thumb of the user accessible to a second of the grouped input devices and actuating the input devices with the right and left thumbs of the user.

### BRIEF DESCRIPTION OF THE DRAWINGS

The foregoing and other objects of this invention, the various features thereof, as well as the invention itself, may be more fully understood from the following description, when read together with the accompanying drawings, described:

FIG. 1 is an isometric view of an ergonomic hand-held computing device produced in accordance with the present invention.

FIG. 2 is a plan view of an ergonomic hand-held computing device showing the finger grooves in the backside and produced in accordance with the present invention.

FIG. 3 is side view of an ergonomic hand-held computing device shown in FIG. 3 and produced in accordance with the present invention.

FIG. 4 is a plan view of an ergonomic hand-held computing device showing the keys in a polar arrangement and produced in accordance with the present invention.

FIG. 5 is a plan view of an ergonomic hand-held computing device showing the keys in a polar and arcuate rectangular arrangement and produced in accordance with the present invention.

FIG. 6 is a plan view of an ergonomic hand-held computing device showing the keys in an alternate polar and arcuate rectangular arrangement and produced in accordance with the present invention.

For the most part, and as will be apparent when referring to the figures, when an item is used unchanged in more than one figure, it is identified by the same alphanumeric reference indicator in all figures.

### DETAILED DESCRIPTION OF THE PREFERRED EMBODIMENT

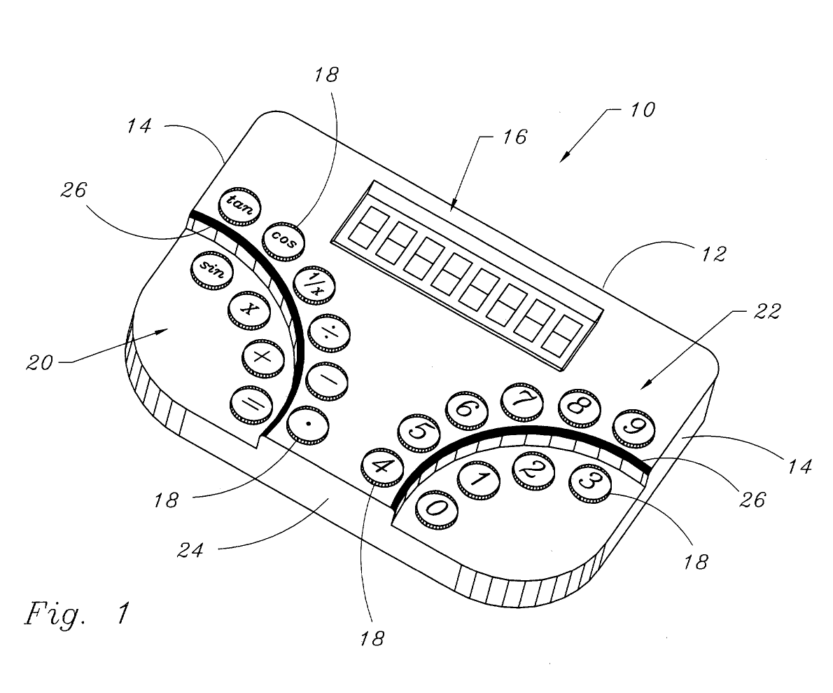

The present invention is an ergonomic hand-held computing device used to optimize the use of the user's thumbs for data input. What is shown in FIG. 1 is an isometric view of a handheld computing device in the form of a calculator 10. In this disclosure, all forms of the computing device are represented as different forms of an electronic calculator. This is the preferred embodiment of the computing device as it pertains to the invention.

The calculator 10 includes a housing 12 with two side portions 14. Between the side portions 14 is provided a display 16. The display 16 is shown throughout the disclosure to be a series of seven segment LCD (liquid crystal display) or LEDs (light emitting diodes) arranged in a horizontal row with a floating decimal point. This is common among traditional calculators. Other more complex calculators are also inherently disclosed as well. This includes displays common to a larger graphing calculator and multiple row seven segment displays. The detail of the display 16 is not critical to the novelty of the invention and is therefore not intended to be limiting to the scope of the invention.

One critical feature is in the arrangement of the buttons 18 or input devices. These buttons 18 are arranged in a pattern, which includes two groups, a left group 20 and a right group 22. What is shown here is a simplified form of the preferred embodiment in that there are two rows of buttons 18 in each group and each row is substantially equidistant from a location unique to each group (20 & 22). In this embodiment, the buttons 18 are arranged about arcs of two concentric circles the center point (location unique to each group) located near the bottom edge 24 of the two adjacent side portions 14. The arcuate arrangement of the buttons 18 is done to provide a more ergonomic means of contact of the buttons 18 by the user's thumbs. With the location unique to each group (in this case the center of the arc) near the trapezium (at the medial end of the 1^{st} metacarpal bone) or the head (distal end) of the 1^{st} metacarpal bone (base of the thumb), this allows for very versatile actuation of multiple buttons 18 without the user significantly moving the rest of their hand. This provides for efficiency of use of the device 10 and full view of the buttons 18 and display 16 in that the user's hands do not block the user's view other than the button 18 being actuated.

The step 26, resembling “stadium seating” for the buttons 18, is done to provide greater unobstructed accessibility to the buttons 18 without inadvertently contacting another button 18. By positioning the buttons 18 that are closer to the hand at a lower level, the more distally located buttons 18 can be actuated by the thumb without fear of contact to the closer buttons 18 as they are being “reached over”. This step 26 is only one of a variety of ways this affect can be achieved. Different buttons can be used which have different resting heights to achieve the same end result. The shape of the upper surface of the device 10 can be sloped instead of stepped as another alternative means of varied height. Also, the closer buttons 18 can also be individually recessed into the upper surface of the device 10 and the more distal buttons can be set above the surface as is typically done. The result of each form provides a varied input device (button 18) height relative to a backside of the device 10.

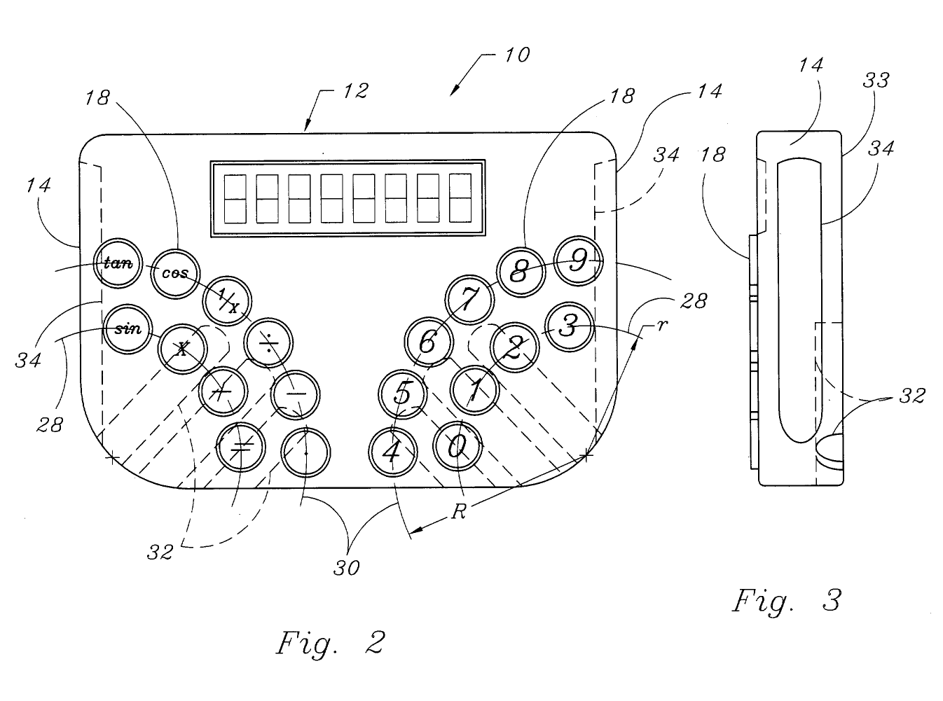

A plan view of the device 10 is shown in FIG. 2. Here the arcs of the concentric circles are better illustrated where “r” is the radius of the smaller arc 28 and “R” is the radius of the larger arc 30. In this view, a set of finger grooves is also depicted by hidden lines. The back grooves 32 are located in the backside of the housing. An index finger grove 34 is positioned in the side portions 14. These finger grooves can be used together, as shown here, or independently in only the backside or only one or both side portions 14.

A side view of the device 10 shows the finger grooves in more detail in FIG. 3. Here the buttons 18 are shown to be at one level, as a variation contrasted by the variable height as shown in FIG. 1. The finger grooves show the back grooves 32 located in the backside 33 and the index finger grooves 34 in the side portion 14 of the housing 12. The finger grooves (31 & 34) provide an increased stability to the housing 12 by the user for any of the fingers of the user, leaving the thumbs free to actuate the buttons 18.

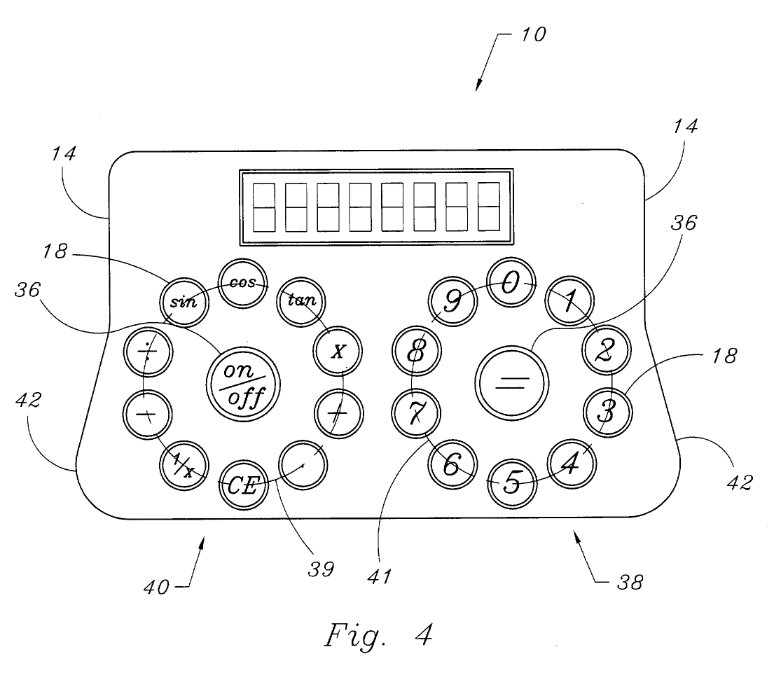

A polar button arrangement is shown in FIG. 4 with a pair of oversized buttons 36 at the centroid of each group. Here a single row set in a polar arrangement is used for each group (right and left). The number buttons 38 on the right and the function buttons 40 on the left. The specific detail of which buttons are used in which position (38 or 40) is not considered critical to the novelty of the invention but more a factor of design choice. In this arrangement, the enlarged buttons 36 are again substantially equidistant from a location unique to each group, or in this case the centers of the circles (39 & 41). In such an arrangement the base of the thumb is best positioned near the centroid of each group. To enable the user's hands be supported in such a fashion, the side portions 14 include a palm grip 42. This is an extension that nests in the palm of the user's right and left hands allowing the base of the thumb to extend over the area of the centroid or as shown here, the oversized keys 36. The fingers of the user then wrap from the palm grip 42 in toward the center on the backside of the device 10.

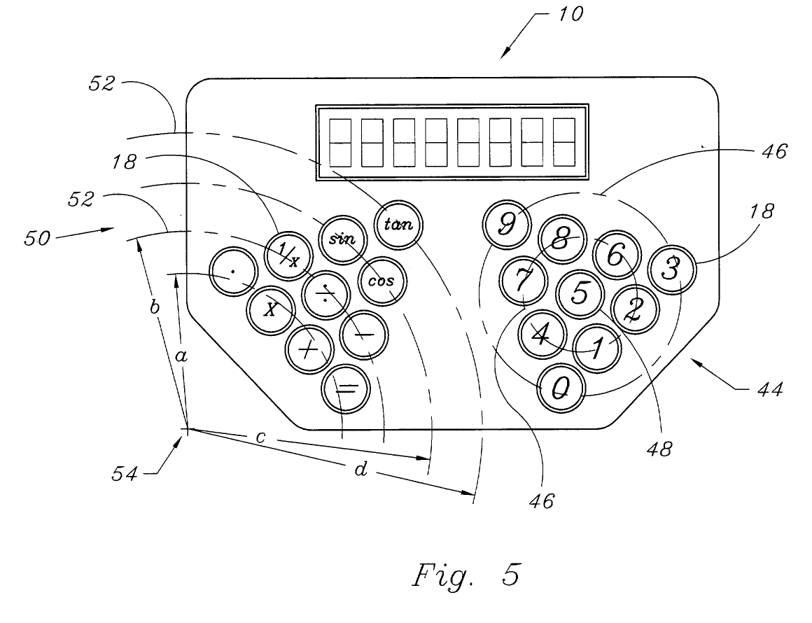

Another variation shows a button arrangement that lies in a set of rows in both polar and rectangular arrangements. In FIG. 5 the right group 44 is shown as a series of parallel lines in a polar arrangement. These are depicted by the concentric circles 46 with the “5” button 48 at the centroid. The same pattern is shown on the left group 50, with the arc lines 52 being comprised of a series of parallel arcs covering all rows of buttons 18. The arc lines 52 including the same center point 54. In such an orientation the use may vary according to the desire of the user. By placing the base of the thumb near the polar center 48, the user works their thumb similar to that as described in FIG. 4, only with multiple rows (circles). This can be contrasted to using the device 10 with the base of the thumb at the common point 54 of the rows of arcs as laid out in the left group 50. Easy access to all buttons 18 would me made by either extending or flexing the bones of the thumb (the distal phalanx, proximal phalanx and first metacarpal bones) to alter the distance of the thumb tip (distal phalanx) relative to the base of the thumb (trapezium bone). This along with lateral movement of the thumb provides access to all buttons 18 with little or no movement of the rest of the hand.

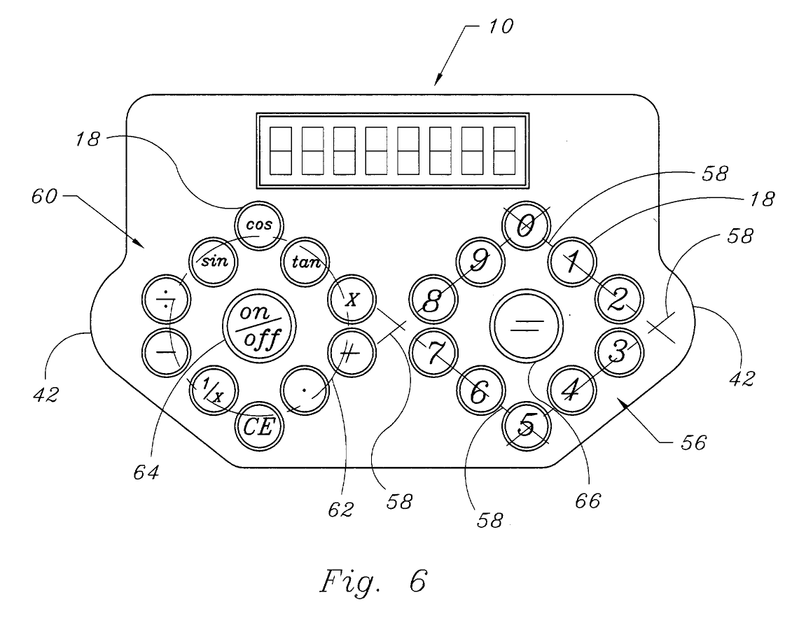

Another variation is depicted in FIG. 6, this time with a common centroid illustrated in both a rectangular and a polar arrangement. The right side buttons 56 are arranged in a rectangular format as shown by the parallel lines 58. The left side buttons 60 show a continuous arc or circle 62 that passes over each peripheral button 18. The on/off button 64 and the equal button 66 are located at the centroid of the left side buttons 60 and the right side buttons 56 respectively. Though the centers of the buttons 18 are not along the continuous arc 62, the arc does cover a portion of each of the peripheral buttons 18. Therefore any pressure applied by the user to a button 18 along that arc 62 would perform the intended task of actuating the button 18. As such the buttons can be substantially equidistant from the common point, which in this case is the centroid, and still function as intended. This is similar to the arcs 52 shown in FIG. 5.

In FIG. 6, since a common point of the centroid is used (64 & 66) it can be desirable to have a palm grip 42, as is shown here. Here the palm grip 42 is located more toward a line that would connect the centroid of the right and left groups. This is another variation in placement of the palm grip 42 and could be used in any of the disclosed button layouts.

What is claimed is:

1. A hand-held computing device comprising:
a housing including two adjacent side portions;
a display device located between said portions; and
a pair of grouped input devices disposed between said side portions and arranged in a pattern including least one row, such that each input device in each row is substantially equidistant from a location unique to each group.

2. A computing device as in claim 1, wherein said input devices are pressure sensitive buttons.

3. A computing device as in claim 1, wherein said pattern includes an arc.

4. A computing device as in claim 1, wherein said pattern includes at least two substantially parallel arcs.

5. A computing device as in claim 1, wherein said at least one row includes a row arranged in a polar coordinate system.

6. A computing device as in claim 1, further comprising a palm grip extending from each of said two adjacent side portions.

7. A computing device as in claim 1, wherein said at least one row includes a row arranged in a rectangular coordinate system.

8. A computing device as in claim 1, wherein said location unique to each group is near the centroid of each group.

9. A computing device as in claim 1, wherein said location unique to each group is near each of said two adjacent side portions.

10. A computing device as in claim 1, wherein said location unique to each group is near a bottom edge of said two adjacent side portions.

11. A computing device as in claim 1, further comprising at least one finger grove in at least one of said two adjacent side portions.

12. A computing device as in claim 1, further comprising a varied input device height relative to a backside.

13. A computing device as in claim 12, wherein said at least one row includes two rows, each row providing a unique height relative to said backside.

14. A computing device as in claim 13, wherein a row nearer said location unique to each group is lower than a row further away from said location unique to each group.

15. A computing device as in claim 1, further comprising at least one finger grove in a backside of said housing.

16. A hand-held computing device comprising:
a housing including two adjacent side portions;
a display device located between said portions; and
a pair of grouped input devices disposed between said side portions and arranged in a pattern of least one row, wherein each row can be connected by an arc, the arc of each row providing a substantially common center at a location unique to each group.

17. A computing device as in claim 16, wherein said input devices are pressure sensitive buttons.

18. A computing device as in claim 16, wherein said pattern includes an arc.

19. A computing device as in claim 16, wherein said pattern includes at least two substantially parallel arcs.

20. A computing device as in claim 16, wherein said at least one row includes a row arranged in a polar coordinate system.

21. A computing device as in claim 16, further comprising a palm grip extending from each of said two adjacent side portions

22. A computing device as in claim 16, wherein said at least one row includes a row arranged in a rectangular coordinate system.

23. A computing device as in claim 16, wherein said substantially common center is near the centroid of each group.

24. A computing device as in claim 16, wherein said substantially common center is near each of said two adjacent side portions.

25. A computing device as in claim 16, wherein said substantially common center is near a bottom edge of said two adjacent side portions.

26. A computing device as in claim 16, further comprising at least one finger grove in at least one of said two adjacent side portions.

27. A computing device as in claim 16, further comprising a varied input device height relative to a backside.

28. A computing device as in claim 27, wherein said at least one row includes two rows, each row providing a unique height relative to said backside.

29. A computing device as in claim 28, wherein a row nearer said substantially common center is lower than a row further away from said substantially common center.

30. A computing device as in claim 16, further comprising at least one finger grove in a backside of said housing.

31. A method of using a computing device including the steps of:
providing a hand-held computing device including:
a housing including two adjacent side portions;
a display device located between said portions; and
a pair of grouped input devices disposed between said side portions and arranged in a pattern including least one row, such that each input device in each row is substantially equidistant from a location unique to each group;
grasping said computing device by a user with a right thumb accessible to a first of said grouped input devices and a left thumb of the user accessible to a second of said grouped input devices; and
actuating said input devices with the right and left thumbs of the user.
